(19) United States
(12) Patent Application Publication
(10) Pub. No.: US 2003/0236836 A1
(43) Pub. Date: Dec. 25, 2003

(54) System and method for the design and sharing of rich media productions via a computer network

(76) Inventor: Ernest Mark Borthwick, Washington, DC (US)

Correspondence Address: MORGAN LEWIS & BOCKIUS LLP, 1111 PENNSYLVANIA AVENUE NW, WASHINGTON, DC, 20004, US

(21) Appl. No.: 10/392,401

(22) Filed: Mar. 20, 2003

Related U.S. Application Data
(60) Provisional application No. 60/366,361, filed on Mar. 21, 2002.

(51) Int. Cl. G06F 15/16

(52) U.S. Cl. 709/204

(57) ABSTRACT

A system for designing and sharing rich media productions on client computers on a computer network. The system includes at least one remote computer, at least one author computer, at least one recipient computer and at least one host server. The remote component stores elements that are to be used in a rich media production. The author computer creates the rich media production by importing elements from at least the one remote component. The host server includes multiple components that enable the author computer to create the rich media production and that enable the recipient computer to access the rich media production. Upon creating the rich media production, the author computer associates a text record with the rich media production and stores the text record on the host computer. The text record is used to identify elements that were used to create the rich media production. The host server transmits a message from the author computer to the recipient computer. The message includes information for enabling the recipient computer to access and recreate the rich media production with the text record.

This application claims the benefit of U.S. Provisional Application No. 60/366,361, filed on Mar. 21, 2002, hereby incorporated by reference.

### FIELD OF THE INVENTION

The present invention relates to a system and method of sharing information over a computer network, and more particularly, relates to a system and method for designing, editing, and sharing rich media productions over a computer network in accordance with the principles of the invention.

### BACKGROUND OF THE INVENTION

Computers are typically used to create rich media productions by integrating multimedia components into Internet contents, such as web sites with online advertisements, editorial contents, and on-line presentations. The resulting media files are stored in proprietary file formats that have limited cross platform compatibility. Rich media productions are typically shared as email attachments or over computer networks, such as the Internet. Attaching rich media production files to emails is inconvenient and expensive since these files are typically large, and recipients must download and store them on client computers. After receiving a rich media production, the recipient must generally install large proprietary software applications on client computers or on locally accessed servers, along with libraries of digital graphic art.

Recent developments in software applications enable subscribers to access and use rich media productions in server applications. Such server applications typically rely on pre-designed and pre-installed templates and images stored on the server. This limits the range and flexibility of the designs that can be achieved by the server applications. Subscriptions to server applications are a major cost factors for application service providers because they are required to store extensive client files on their servers and support heavy bandwidth loads.

There is currently no system or method for sharing rich media productions without requiring large storage space on host servers for uploads and downloads and without requiring users to send the rich media productions as email file attachments. Current methods also do not permit application service providers to share rich media productions by using storage and bandwidth resources from larger networks that already store the rich media elements for a given production. Rather, current methods require that service providers store the rich media elements for each production on their servers.

Other developments in web-based software, such as HTML, Computer Aided Design (CAD), and browser-enabled tools using JavaScript, allow developers to display graphic formats within an Internet browser. However, these developments do not allow easy on-line manipulation of the underlying graphics files. Web-base software also do not allow relatively small rich media production tools to be downloaded in less than a minute using standard narrow bandwidth dial up connections. Moreover, they do not allow recipients of the production to access a small-sized viewer for purposes of viewing and interacting with the production. Furthermore, web-based software do not permit creators of rich media productions to add movement to still images without recourse to timelines or other timeline based interfaces. Web-based software also do not allow the recipients of the rich media productions to edit them using the rich media design tool in the same manner as was used by the creator of the rich media productions.

Innovative products and structures are still needed to increase the accessibility to rich media productions over the Internet. Innovative systems and methods are needed to enable users to access small-sized, client-side software on host servers, where the clientside software is downloaded to the client computer and used to create rich media productions by accessing and manipulating graphic files stored in multiple Internet locations.

### SUMMARY OF THE INVENTION

The present invention relates to a system for designing and sharing rich media productions on client computers on a computer network. The system includes at least one remote computer, at least one author computer, at least one recipient computer and at least one host server. The remote component stores elements that are to be used in a rich media production. The author computer creates the rich media production by importing elements from at least one remote component. The host server includes multiple components that enable the author computer to create the rich media production and that enable the recipient computer to access the rich media production. Upon creating the rich media production, the author computer associates a text record with the rich media production and stores the text record on the host computer. The text record is used to identify elements that were used to create the rich media production. The host server transmits a message from the author computer to the recipient computer. The message includes information for enabling the recipient computer to access and recreate the rich media production with the text record. The system also includes means for downloading a writer template from the host server to the author computer prior to creating the rich media production and means for downloading a reader template from the host server to the recipient computer prior to accessing the rich media production. The downloaded writer template enables the author computer to import multiple elements from at least the remote component and create the rich media production. The downloaded reader template enables the recipient computer to access the text record to recreate the rich media production on the recipient computer.

The inventive system also include a method for designing and sharing rich media productions on client computers on a computer network. The method includes the steps of executing a web browser with a player for launching a writer template on an author computer; downloading the writer template from a host server; launching the writer template on the player; selecting and importing graphic objects into the writer template; manipulating the imported graphic objects to create a rich media production; generating an email record with the address of at least one recipient; generating files for the rich media production and sending the files to the host server; accepting and reading the files on the host server and assigning each variable in a variable file to a corresponding variable category in a unique text data string that is stored on the host server; inserting a unique file name of the text data string in a URL that is associated with the text data string and generating an HTML page that provides options for accessing a reader template; and using, by a recipient computer, the HTML page to access the reader template and the text data string and thereby recreate rich media production.

The inventive system also includes a client computer for designing and sharing rich media productions on a computer network. The client computer includes a writer template and a web browser. The writer template includes core functions for creating a rich media production. The writer template is used to communicate with the host server that stores a plurality of components. The web browser includes a player for launching the writer template. The client computer also include means for downloading the writer template, for downloading graphic objects from at least one external component, for manipulating the downloaded graphic object to create the rich media production, for generating files for the rich media production and for sending the files to the host server. The host server accepts the files, generates and stores a unique text data string that is associated with the rich media production and transmits access to the text data string to a recipient that uses the text data string to recreate the rich media production.

The invention also includes a client computer for accessing a rich media production that is stored on a host computer. The client computer includes a reader template and a web page. The reader template enables the client component to access the rich media production. The reader template is used to communicate with a host server that stores multiple components. The web browser includes a player for launching the reader template. The client computer also includes means for activating a URL in an email that launches the web browser, for accessing a unique HTML page by clicking the URL in the email, for downloading the reader template, for launching the reader template that accesses and reads a unique data string from the host server and uses the data string to locate images and media used in the rich media production, and means for loading the images and media into the reader template and thereby reproducing the original appearance and properties of the rich media production.

Additional features and advantages of the invention will be set forth in the description that follows, and in part will be apparent from the description, or may be learned by practice of the invention. The objectives and advantages of the invention will be realized and attained by the system and method particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention. In the drawings:

FIG. 1 illustrates a computer network that serves as a dynamic rich media production storage and retrieval entity in accordance with the principles of the invention;

FIG. 2A illustrates how levels are subdivided into multiple layers;

FIG. 2B illustrates the stacking order of components in level 0 of FIG. 2A;

FIG. 3 illustrates how the present invention associates each imported graphic object with a corresponding container object in the writer template;

FIG. 4A illustrates how the user displays graphic objects in a comprehensive view;

FIG. 4B illustrates how the user displays graphic objects in separate scenes;

FIG. 5 illustrates how menu components are grouped together in the writer template;

FIG. 6 illustrates steps implemented in the present invention to allow the user to access and incorporate graphic objects that are stored on other web sites;

FIG. 7 illustrates what is displayed on the writer template when the steps of FIG. 6 are perform; and

FIG. 8 illustrates steps implemented in the inventive system for identifying and importing graphic objects from various locations within the network.

### DESCRIPTION OF PREFERRED EMBODIMENTS

Reference will now be made in detail to the preferred embodiments of the present invention, examples of which are illustrated in the accompanying drawings. The present invention described below extends the functionality of the inventive system and method for designing, editing, and sharing rich media productions over a computer network.

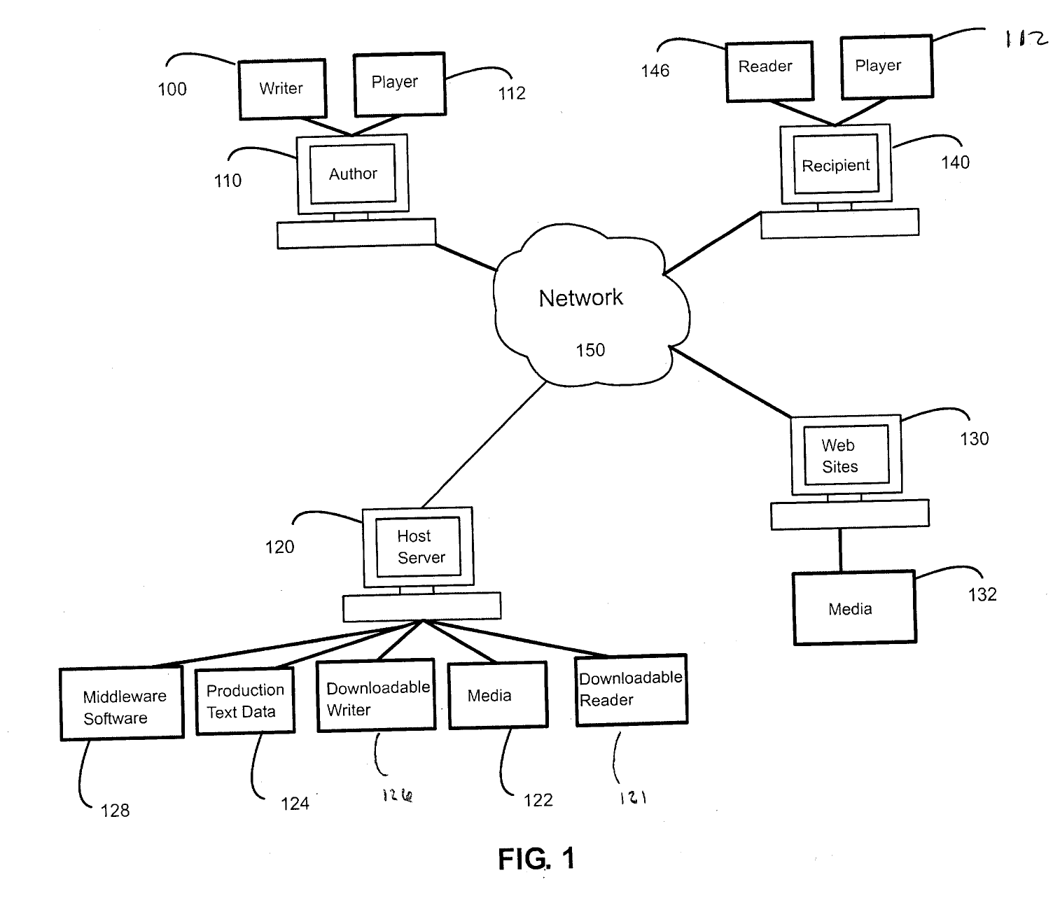

FIG. 1 illustrates a computer network that serves as a dynamic rich media production storage and retrieval entity. The computer system includes at least one author computer 110, at least one recipient computer 140, web sites 130 that are stored on various servers, and at least one host computer 120. Components 110, 120, 130, and 140 are connected by a network 150. A creator of a rich media production uses author computer 110 to create the rich media production with files from locations, such as web sites 130 and host computer 120, on computer network 10. Upon creating the rich media production, the creator stores an associated text record on host computer 120. Thereafter, users of other components on computer system 10, for example recipient computer 140, may use the text record to recreate and access the rich media production.

In a preferred embodiment of the invention, author computer 110 includes a writer template 100 and a Web browser, such as Microsoft Internet Explorer™. Recipient computer 140 also includes a Web browser. The browsers in computers 110 and 140 preferably include a player 112, such as Flash 6, that hosts writer template 100 and reader template 146. Writer template 100 is a copy of downloadable writer 126 on host server 120. Writer template 100 provides the core functionality for the creation of the rich media production and provides a vehicle for author computer 110 to communicate with host server 120. Reader template 146 is a copy of downloadable reader 121 on host server 120. Reader template 146 enables a recipient of a rich media production to recreate and access the rich media production.

Specifically, writer template 100 enables the creator to download disparate media files for creating rich media productions from external components, such as host server 120, via network 150. For example, the creator may use writer template 100 to download menus and disparate rich media elements 122 and 132 as needed from host server 120 and other network locations, such as web sites 130. Prior to or in conjunction with downloading the template from downloadable writer 126, the creator may create at least one personal account on one or more host servers that are associated with media storage sites. The creator may thereafter upload personal media files from author computer 110, associate the personal media files with personal accounts on host servers, and store the personal media files on the associated host servers. The creator also uses writer template 100 to import selected media files from one or more personal accounts or to import media files belonging to other users that have been stored on sites that are accessible by author computer 110.

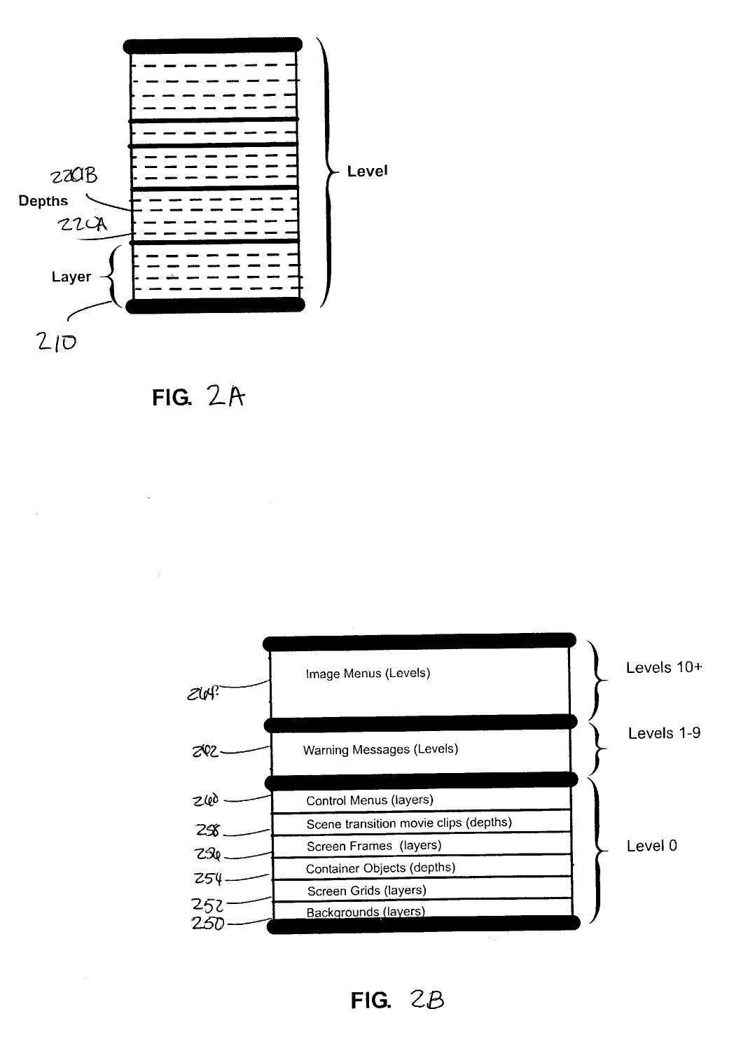

After the creator downloads writer template 100, the creator interfaces with writer template 100 through player 112. Player 112 interacts with object oriented scripting languages, such as Macromedia's ActionScript™. A preferred embodiment of the system implements the Flash 6 Player or higher versions distributed by Macromedia Corporation. Player 112 displays instances of downloaded graphic objects as if they were in a stack of transparent layers. The lowest and basic level is referred to as “level 0” while other levels are designated by their successive numbers. Level 0, as the root or base level of the player device, is represented by the main movie timeline used in ActionScript™. FIG. 2A illustrates how level 0, like other levels, is subdivided into multiple “layers” as illustrated by 210. Any layer can be further subdivided into multiple “depths” as illustrated by 220A and 220B. The location of each graphic object in this hierarchy of levels, layers, and depths is uniquely identified and recorded by writer template 100 and is thereafter read and reconstructed by reader template 146 to recreate the rich media production.

Level 0 includes most of the functional components of the downloaded writer template. Placement of objects in level 0 enables the creator to alter the depths of graphic objects within a layer. The upper levels include additional components that are positioned for viewing on top of the lower functional components in level 0. FIG. 2B illustrates the stacking order of components in level 0. Backgrounds 250 are instances of background images, some of which can be viewed in combination with other background images. Backgrounds 250 may be placed on multiple levels. Screen grids 252 are temporary guides for placement of images on the screen. Screen grids 252 may be placed on multiple levels. Container objects 254 are scripted software objects within which imported graphic objects are contained and manipulated. Container objects 254 may be placed at multiple depths within a level. Screen frames 256 are multiple layered frames surrounding the perimeter of the work area of writer template 100. Screen frames 256 may be placed at multiple levels. Scene transition movie clips 258 are movies that enable transitions between scenes in writer template 100 to be displayed in different ways. Scene transition movie clips 258 may be placed at multiple depths within a layer. Control menus 260 are any menus that serve to load or manipulate objects in player 112 or that serve to add additional functional menus or objects, such as music or an email function. Control menus 260 may be placed in multiple levels. Other elements and objects integral to the working of writer template 100 that occupy upper levels, for example, are warning messages 262 on Levels 1 through 9 and image menus 264 on Levels 10 and above.

Returning to FIG. 1, prior to creating a rich media production in author computer 110, the creator launches the web browser and connects author computer 110 to host server 120. The creator preferably provides a password to access and download a template from downloadable writer 126 to writer template 100. The downloaded writer template is designed to host and interact with menus that are downloaded into writer template 100 from host server 120. Thereafter, writer template 100 is executed by player 112. Writer template 100 initially appears in player 112 as a largely empty work area with icon buttons displayed as a group along one side of the work area. These icons are designed to import menus, from host server 120, that correspond to specific functional tasks to be performed in writer template 00. The menus are saved in the client's browser cache to prevent repeated downloading of the same menu. Examples of icon buttons displayed in player 112 include an Import Menu Icon for importing an import menu that controls how images are imported and displayed in writer template 100; a Navigate Icon for importing the navigate menu that enables the user to display different scenes in a rich media production; an Edit Menu Icon for importing an edit menu that may display icons for enabling the user to resize, rotate, shape, or color selected images on the screen; a Backgrounds Menu Icon that may display additional icons representing menus used to insert different background levels and frames; an Animation Menu Icon for importing an animation menu that enables the user to make still images move on the screen; a Send Menu Icon for importing a menu that enables the user to share a rich media production using email; an Audio/Video Menu Icon for importing a menu that enables the user to add music, voice, or videos in a rich media production; a Print Menu Icon that launches the print function of the host device to enable the user to print any scene of a rich media production; and a Help Menu Icon that imports help and usage instructions. Each of the above mentioned imported menus can exist simultaneously in the work area with other menus. In a preferred embodiment of the present invention, each floating menu can be dragged anywhere in the work area and minimized.

After loading writer template 100 into player 112, the creator may download disparate graphic files into writer template 100. The creator combines and manipulates downloaded graphic files to create rich media productions. Each imported graphic object is associated with a container object 254 (FIG. 2B), such that actions performed on one are assumed to be performed on both. Each container object 254 in writer template 100 is designed with a set of pre-named variables that identify the different properties of the container object and any imported graphic image associated with the container object. When the writer template is downloaded, the writer template includes a set of default variables. Examples of the default variables include a variable that sets the background color, a variable that is associated with the initial depth level for each container objects, a variable that is associated with the first scene to start, and a variable that is associated with the depth level for each menu or icon

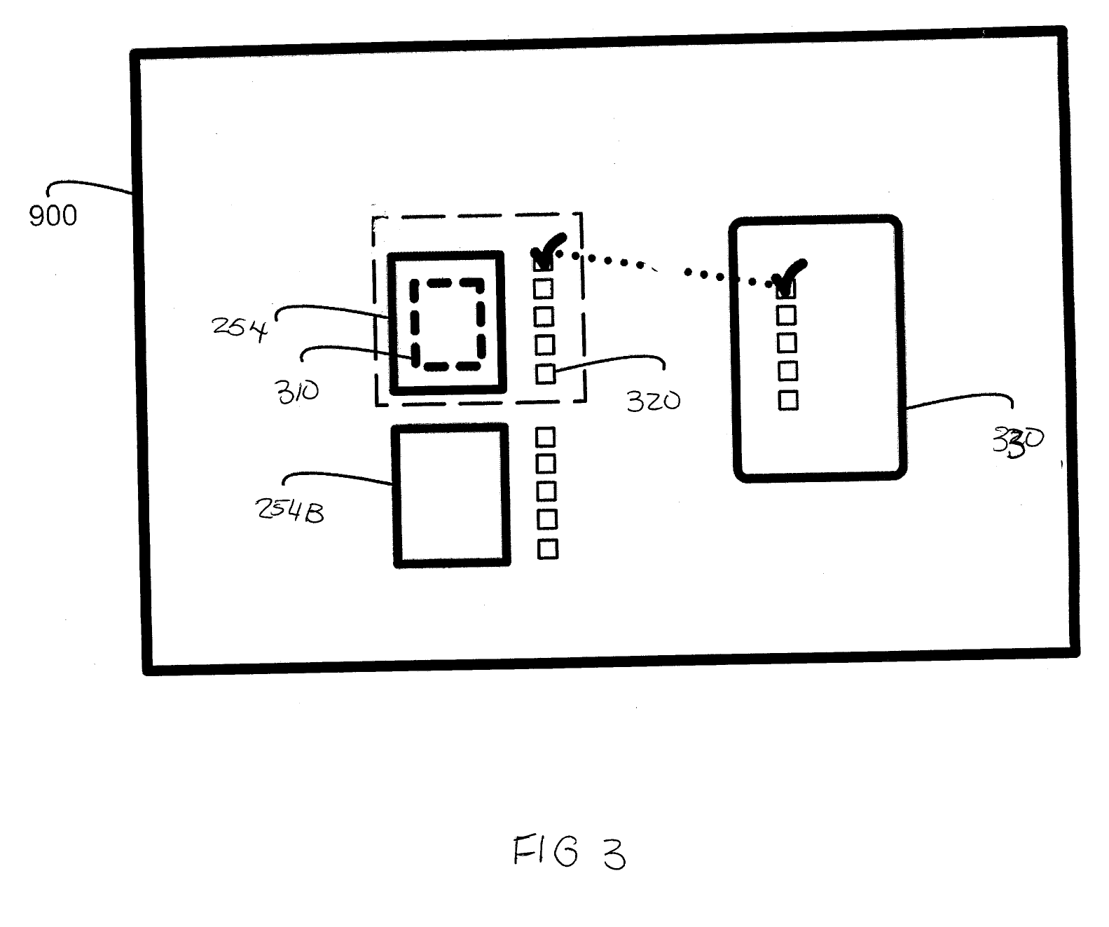

FIG. 3 illustrates how the present invention associates each imported graphic object 310 with a corresponding container object 254 in writer template 100. Container object 254 is designed to accept inputs to multiple variables 320 that determine the properties and appearance of imported graphic object 310. After the creator imports graphic object 310 into writer template 100, the creator selects graphic object 310 and container object 254, for example, with a mouse click on graphic object 310 and/or on menu 330 that is used to interact with variables 320. This allows the user to manipulate that appearance of graphic object 310. Note that menu 330 does not interact with container object 254B because container object 254B is not associated with an imported graphic object.

In the inventive system, graphic objects may be displayed in a scene, i.e., multiple container objects 254 in a layer which, along with any imported graphic object 310 they may contain, are uniquely visible as a group to the exclusion of all other objects in other layers. A user may determine whether writer template 100 displays graphic objects 310 in separately viewable scenes or in a single, comprehensive view with all scenes.

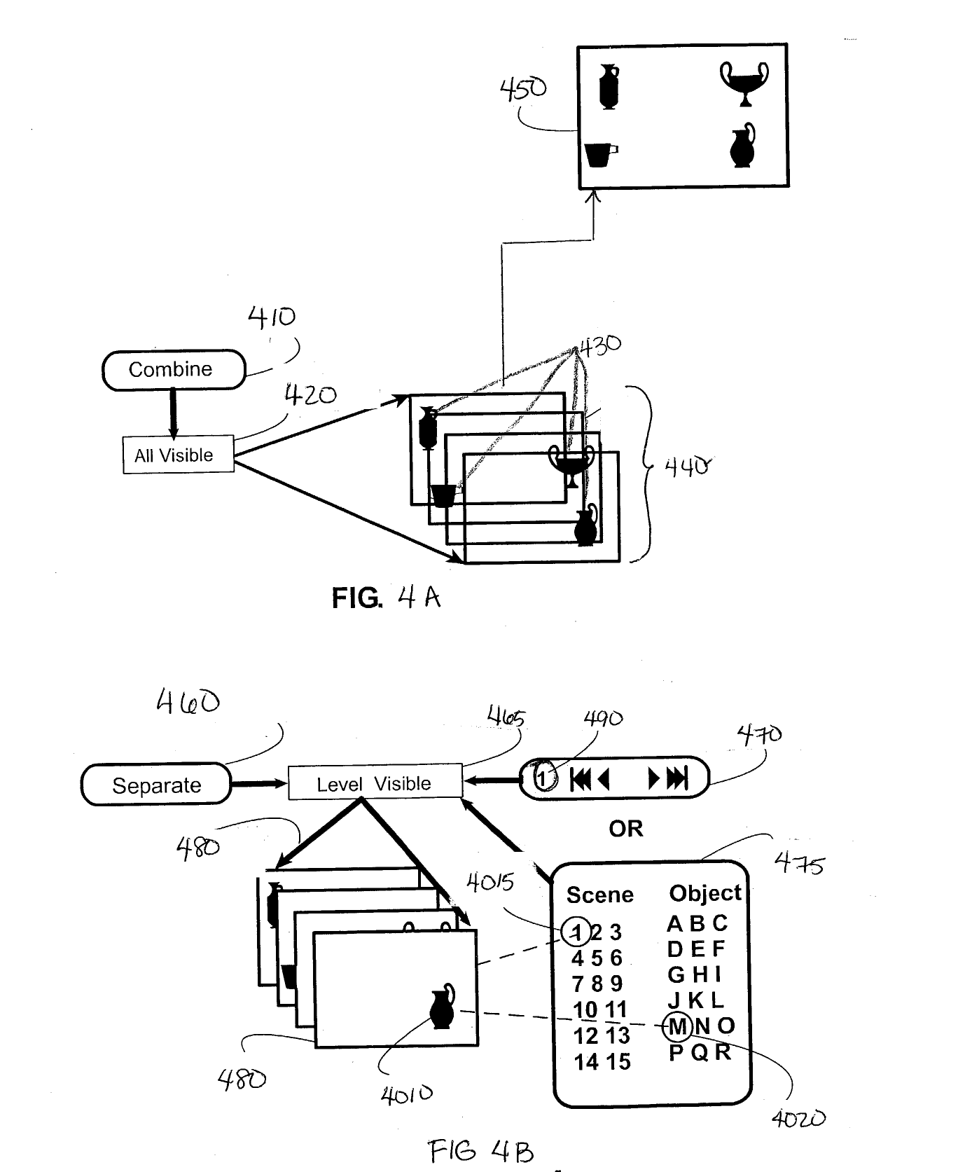

FIG. 4A illustrates how the user displays graphic objects in a comprehensive view. As illustrated in FIG. 4A, the user may use menu button 410 to select a script 420 which sets the visible value to true for all container objects 430 in all scenes 440. The result is to display all scenes or levels in writer template 100 or reader template 146 as being transparent to all others scenes or levels as illustrated by 450.

Alternatively, FIG. 4B illustrates how the user displays graphic objects in separate scenes. As illustrated in FIG. 4B, the user selects menu button 460. Menu button 460 executes script 465, which interacts with scripted menu interfaces 470 and 475 to toggle between groups of container objects. Some container objects have their visibility value set to “true” while the visibility values of all other container objects are set to “false”. As a result, scenes 480 and 485 can be displayed separately. Menu interfaces 470 and 475 can be used simultaneously or separately to display separate scenes. Interface 470 is illustrated as a standard “slide show” navigation menu that enables the user to navigate forward and backward through the scenes. Interface 470 displays the currently selected scene number 490. Similarly, menu interface 475 displays control buttons that enable the user to select the specific scene that has the visible value set to true for all of its container objects while the container objects in all other scenes are invisible. An advantage of interface 475 is that it allows the user to identify and select each container object within a scene by designating the container object with a menu icon or letter that functions as a button 4015. Each button 4015 is linked to a unique container object 4010 in a specific scene. As a result, when the user manually selects graphic object 4010 and its associated container object, the selection causes a specific container object button 4020 on menu 475 to be highlighted within a specific scene 4015. In FIG. 4B, object 4010 is shown selected and may be referred to as “Scene 1, Object M” with Scene button “1” and Object button “M” highlighted respectively by a circle or other known means. Two-way scripted interactivity between each container object and its button in the menu interface enables any imported graphic object and its container object to be selected either by clicking the two categories of buttons or by clicking the graphic object directly, thereby highlighting the associated pair of buttons.

Menus in writer template 100 (FIG. 1) may be designed to change the stacking order depth of a selected graphic object relative to other graphic objects displayed in the work area in writer template 100. Thus, a menu button may be designed to create a condition whereby each successive graphic object in the work area is moved to the top of the object stacking order in a layer. Another menu button may be designed to create a condition in which each successive graphic object in the work area exchanges depths with the object immediately above it. Yet another menu button may be designed to stop the conditions from dynamically changing the stacking order of objects until a button associated with a specific condition is subsequently clicked.

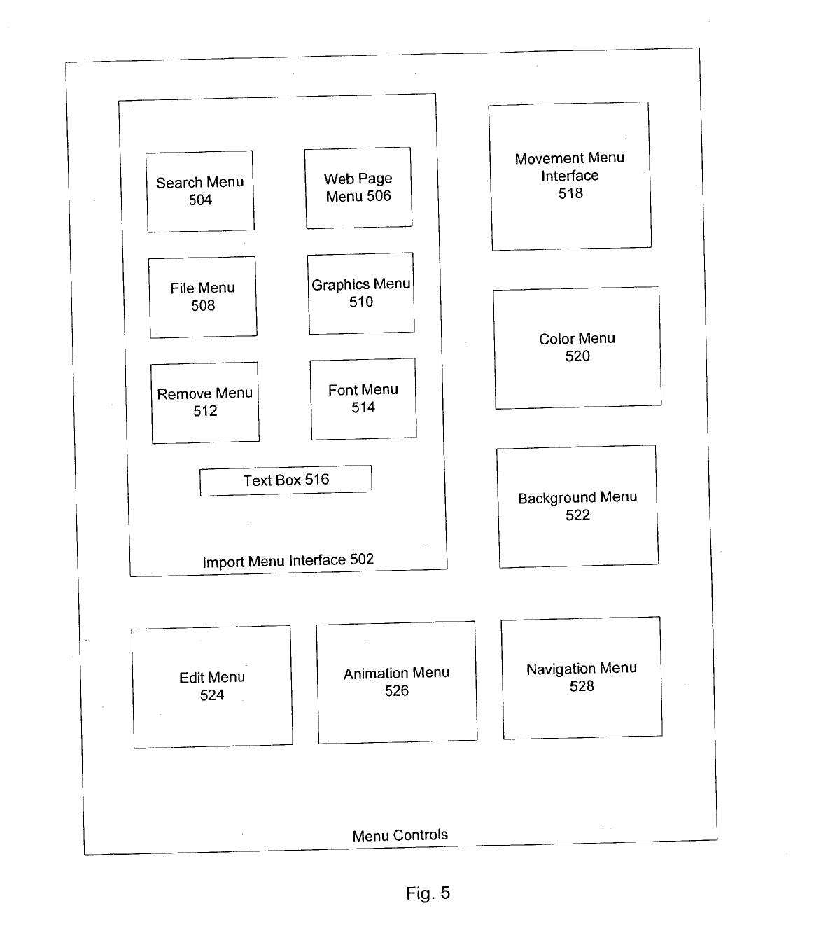

Menu controls 500 are designed to allow the creator to select, access, import and display graphic objects. FIG. 5 illustrates how menus are grouped together in writer template 100. In the preferred embodiment, the import functions are grouped together in an import menu interface 502. Import menu interface 502 is activated by clicking the Import Icon. Some menus in import menu interface 502 provide a method for importing a graphic object into the work area in writer template 100. Import menu interface 502 also includes a remove menu 512 that is designed to remove a selected imported graphic object from its container object. Remove menu 512 may be designed to remove all the imported graphic objects from their respective container objects within a single scene. Remove buttons may appear on more than one menu or in more than one location within writer template 100.

A search menu 504 is an example of an import menu in import menu interface 502. The creator may use search menu 504 on import menu interface 502 to implement an image search method that launches a commercial search engine specializing in keyword searches for available media files on other web pages. The user may, for example, enter “horse” and the search engine will display multiple horse images. The user may then select the URL associated with one of the displayed horse images. The user may then enter the URL into a text box 516 in import menu interface 502. Text box 516 is preferably enabled by player 112 to link the URL to writer template 100. Thereafter, when the user clicks a predefined button on import menu interface 502, the image associated with the selected URL is imported into writer template 100. As is apparent to one skilled in the art, the entry of the URL into import menu interface 502 may be accomplished by manually pasting it into a text box or it may be done by other known methods of interaction with menu interfaces.

In another example, the creator may also use a web page menu 506 on import menu interface 502 to implement a personal web storage method for launching web pages, including web pages on host server 120, where the user previously stored graphic files. In another example, the creator may also use a file menu 508 on import menu interface 502 to implement a method for accessing graphic files, stored on host server 120, that are available for download to reader and writer templates 146 and 100. File menu 508 preferably provides access to an HTML page containing a list of the graphic files. When the user double clicks on a file name accessed by file menu 508, a URL associated with the selected file is displayed by player 112. This enables the creator to insert the URL into writer or reader templates 100 and 146 and thereby import the file into writer or reader templates 100 and 146.

In yet another example, the creator may also use a graphics menu 510 on import menu interface 502 to implement a method of selecting graphic files stored on a host server and to download the selected graphic files into writer template 100. Graphic menu 510 provides an interface that presents multiple menu categories, any one of which if selected, presents a palette of menu icons. Each menu icon represents and is linked to image files on host server 120. When the user clicks on one of the menu icons, the system downloads the associated file from server 120 to writer template 100.

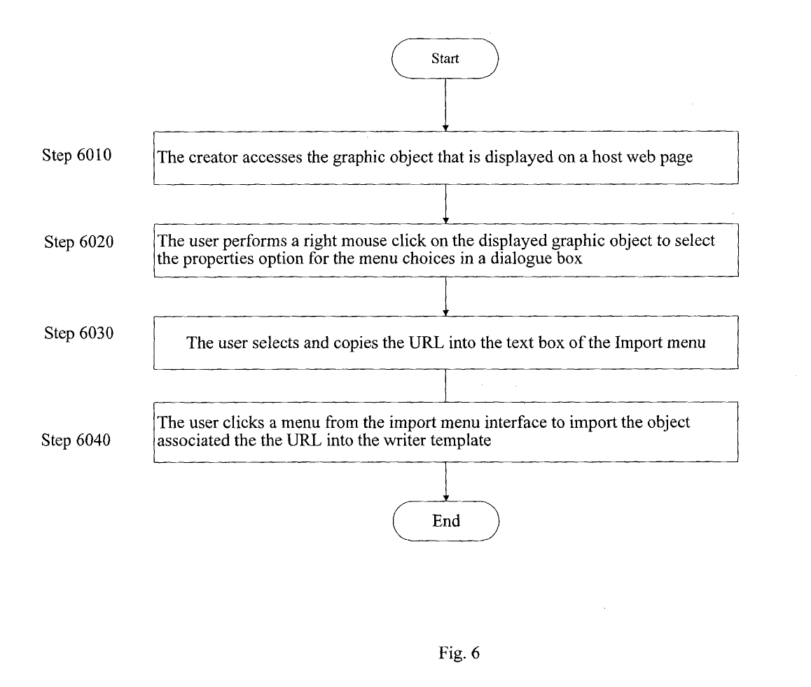

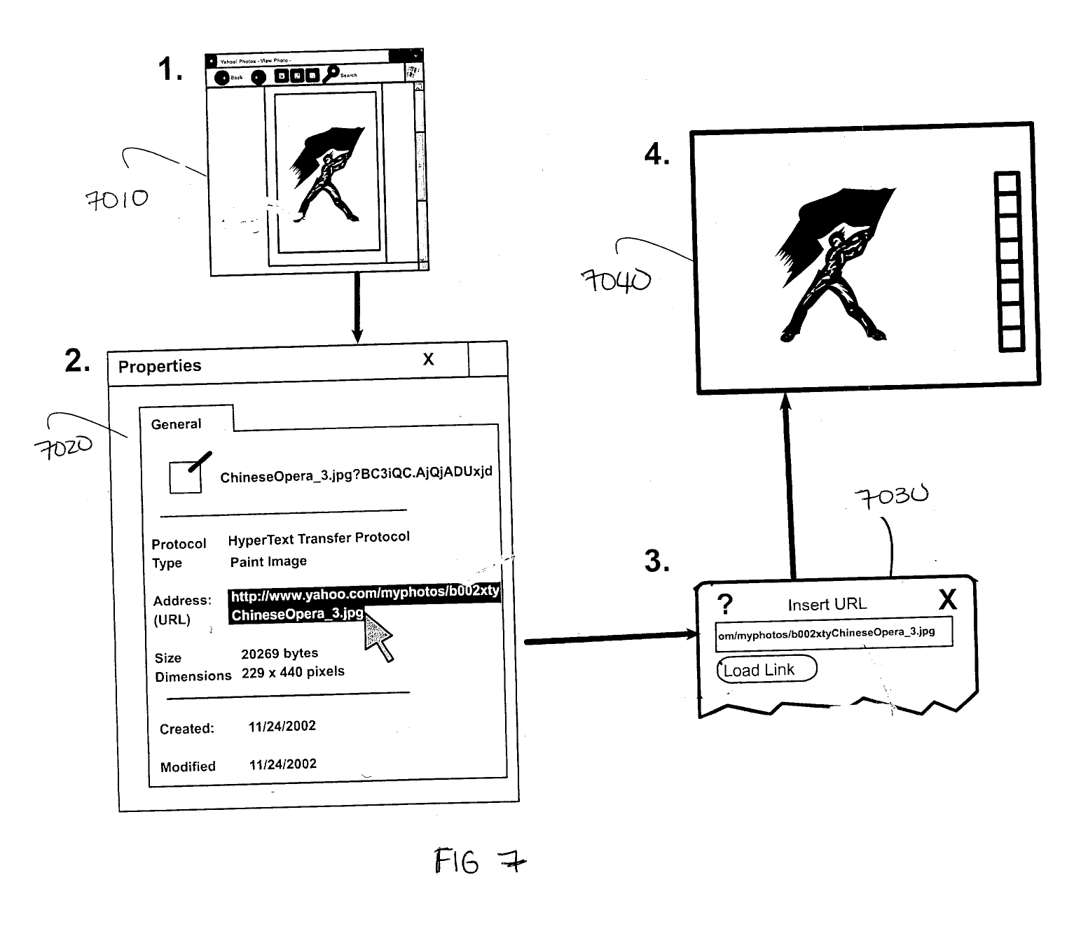

FIG. 6 illustrates yet another example of steps implemented in the present invention to allow the user to access and incorporate graphic objects that are stored on other web sites. In Step 6010, the creator accesses the graphic object that is displayed on its host web page. In Step 6020, the user performs a right mouse click on the displayed graphic object to select the properties option from the menu choices in the dialogue box. The properties option displays the URL of the graphic object. In Step 6030, the user selects and copies the URL into the text box of the Import menu. In Step 6040, the user clicks a menu from the import menu interface to import the object associated with the URL into writer template. FIG. 7 illustrates what is displayed on writer template 100, when steps 6010-6040 of FIG. 6 are perform. As such, Step 6010 corresponds with Step 7010, Step 6020 corresponds with Step 7020, and so on. In Step 7020, the graphic object is a JPEG photograph

Some menus in the system include scrolling text for indicating categories of rich media content. When the user selects a text category, the system downloads a further menu showing multiple text subcategories of the rich media content. When the user selects a text subcategory, the system downloads a further menu containing thumbnail images of graphic objects. Each of the thumbnail images is linked to a rich media file on the server. By selecting the thumbnail image, the user is able to download the thumbnail image to the work area where the image is associated with a container object.

Referring to FIG. 5, a preferred embodiment of the present invention uses a movement menu interface 518 to manipulate the rotation and dimensions of an object that has been imported into and displayed in the work area. A movement menu is imported into writer template 100 by clicking an associated icon in movement menu interface 518. Movement menu interface 518 includes buttons that control the variables of size, length, width, and rotation (left and right) of a selected active graphic object in writer template 100. Menu buttons are designed to change the variables linked to a selected object by regular and precise increments, thereby causing the real time display of the associated objects that reflect changes in the variable. As such, continuous pressure with the mouse cursor on selected menu buttons causes a correspondingly continuous change in selected variables and in the display of the associated object. For example, when an X-Y button is pressed continuously, it effects a continuous and equal reduction in the x and y axis dimensions of a currently selected graphic object. Similarly, when a Y button is pressed continuously, it affects a continuous reduction in the y axis dimension, and when an X button is pressed continuously, it affects a continuous reduction in the x axis dimension of the currently selected graphic object. Additionally, when a clockwise button is pressed continuously, it affects a continuous clockwise rotation of the selected graphic object. Each of the aforementioned buttons is paired with a button that performs the action on the selected graphic object in the opposite direction or dimension. Smaller incremental changes in the aforementioned variables can be affected by side buttons that are displayed on the side of each of the aforementioned buttons. While the preferred embodiment of the invention requires that the buttons to be clicked or pressed, the same functions can be accomplished by slider controls or keyboard controls. Rotation and size changes can also be accomplished by standard techniques in scripting languages that will permit grasping and turning vector-based graphic objects directly using the mouse cursor. Vertical and lateral movement of the selected graphic object can be affected by continuously pressing any of four predefined arrows in writer template 100.

The user can change the color of a selected object by selecting any color swatch located on a color menu 520 in the work area. The user can also change the base level background color of the work area by selecting a base level background icon and any color button in a menu color palette. Similarly, the user may color an intermediate background on a layer above that of the base level background by selecting an icon that is designed to affect that background level and then selecting a color swatch. The intermediate background can thus be one through which parts of the base background may still be viewed, creating a combination of images and colors. The transparency of any selected background or any selected object in the work area can be changed by pressing on a transparency icon. The transparency icon is designed to change the transparency of any selected object by incremental amounts until the object is completely transparent or invisible. It is apparent to one skilled in the art that other designs, for example a color wheel menu or a grid style menu, may be used to change the color of selected objects in writer template 100.

Color swatches on color menu 520 can also be used to color multiple components, such as frame parts located on separate layers. The frame parts may be placed around the work area and above the layers of imported objects or backgrounds. Each frame part typically includes multiple separate vector file objects that are loaded simultaneously when the frame part is selected from a menu of frame selections. When the user selects a frame part and a color swatch, the color of the frame part will be altered. Thereafter, when viewed together, the separate file objects representing the frame parts appears to include a completed picture or pattern.

The inventive system includes a background menu interface 522 for selecting and loading different background levels into writer template 100. The base level background of writer template 100 may be overlain by multiple additional background levels. Other backgrounds selected from a menu of optional backgrounds may thereafter be inserted in the overlaid background. As such, multiple background images may be inserted on multiple levels in writer and reader templates 100 and 146. In either the writer and reader templates 100 and 146, a lower background image may be partially visible when upper level backgrounds are semitransparent or have openings. Additional backgrounds may be accessed by menus similar to those on the import menu interface.

The creator may also use a font menu 514 on import menu interface 502 to access a menu of font files that are used to insert text into writer template 100. The user's menu choices determine the font type and other characteristics of the text, such as bold or italic style and right or left justification. When the user clicks a selection button, the user is allowed to import an embedded font file of editable text as a text box. The font file is associated with a container object. The embedded font file has the properties of the user-selected style and justification as determined in the menu selections. The text box is typically borderless and transparent except when the mouse is over it. The text box is designed to produce the embedded font that matches the font selected by the user from the menu. The text box can be dragged and dropped by user implemented mouse actions within any part of the work area.

Font menu 514 offers the user menu selections of multiple embedded fonts. The appearance of each embedded font is defined by the negative space rather than the positive space that the letters and figures occupy. The fonts, herein referred to as “mask fonts,” function in the same way as masks that are commonly used in animation effects. The masks reveal an underlying animation or object that can be seen through the open or empty areas of the mask. Mask fonts in the present invention are constructed so that upon keyboard entry the corresponding characters are defined by the empty space they occupy. The surrounding space between the characters is completely filled and opaque. This results in a mask layer whose opening is defined by the characters selected by the user. Spaces between words created with the mask fonts are completely filled by a specified keyboard action, such as but not limited to the underline action, and is used as an integral part of the embedded font. The text created within a text box using the mask font defines an area that is surrounded by a larger mask that covers the larger work area of the presentation. Multiple movie animations and other images that may appear above multiple backgrounds may be inserted on multiple levels beneath the mask font.

Other menus, such as an edit menu 524 and an animation menu 526 may be imported into writer template 100 and used to affect the appearance and behavior of selected a text box. A navigation menu 528 may be imported to facilitate the selection of scenes to be displayed in the work area and the optional types of transition between scenes. Navigation menu 528 offers the user a separate scene option for displaying scenes one at a time. Navigation menu 528 also offers the all scene option for displaying all scenes. When the separate scenes option is selected, the menu interface displays the scene number while the corresponding scene appears in the work area. Navigation menu 528 also offers navigation buttons that are designed to enable the user to click to move on to the next scene or return to previous scenes. Navigation menu 528 also offers a set of options for visual transitions between scenes as they change. Each style of transition may include a movie clip located on an upper layer of Level 0. Each movie clip will occupy a separate depth on the layer. Other transition techniques as would be known to one skilled in the art may be used to effect similar transitional states between scenes.

Objects imported into writer template 100 may appear as animations when the creator imports a file that has already been animated using other software. Alternatively, as shown in FIG. 2B, a container object 254 and its contents can also be animated when the user activates animation instructions that are associated with each the container object in writer and reader templates 100 and 146. According to the inventive system, the user may select an object and specify variables for simple movements. These variables can also be used in combination to perform more complex movements. The user can stop an animation by clicking a button associated with a specific movement or by selecting a stop button. The stop button stops all animations on the selected object.

Commands that cause an object to move can be applied to a container object 254. Upon receiving the commands from an animation menu control template, the graphic object associated with container object 254 performs the animation in the work area until the stop command is applied to the graphic or container object 254. Variables describing these animation properties and their speeds are recorded for each object by writer template 100. An example of the variables describing these animation properties include a transparency or “alpha” variable of a digital graphic object. The alpha variable may be used to determine the time lapse for a specific change based on the steady rate at which an alpha value can be changed even as the alpha value drops below or above the value representing 0 or 100 percent alpha. This enables the user to measure periods of delay associated with an object. For example, the user may measure the period during which an object having faded from the work area remains invisible prior to becoming visible again. Alternatively, animation variables can be designed to respond to a timer script to create the same or similar effects. Examples of animation variables include a left movement variable, a right movement variable, an up movement variable, a down movement variable, a resize larger variable, a resize smaller variable, a rotate clockwise variable, a rotate counterclockwise variable, an x scale increase variable, an x scale decrease variable, a y scale increase variable, a y scale decrease variable, a transparency increase variable, and a transparency decrease variable.

The system also includes an imported animation menu 526 (FIG. 5). Animation menu 526 includes buttons that control specific animation actions. These buttons set variables or combinations of variables for any user-selected object. Actions associated with these variables are typically set to occur as continuous motions, such as steady rotation, or as continuously looping actions, such as a repetition of fading in and fading out. Examples of animation actions associated with these variables include a fade out and fade in action, a spin vertical action, a spin horizontal action, a zoom out and fade action, zoom in and fade action, a rotate counterclockwise action, a rotate clockwise action, a move continuously left action, a move continuously right action, a move continuously up action, a move continuously down action, a pan back and forth-left and right action, a pan back and forth-up and down action, and a rotate alternately left and right in continuous motion action. The speed of each animation action on an object is determined by buttons that set the speed variable on each animation variable. For each animation action, two speed buttons can be clicked to incrementally increase or decrease the speed of the action. Vertical and horizontal pan actions may be designed for multiple distances covered by each the pan action. An action that has been implemented on an object may be turned off when the user clicks on the button that implemented the action. Alternatively, an off button may be provided in the menu for individual actions or groups of actions. Zoom actions, such as zoom out action and zoom in action, are looping actions whose maximum or minimum size at final fade out can be set by buttons showing varying relative size.

Pause buttons on animation menu 526 determine periods of invisibility for animation actions that involve the movement of an animated object off the edge of the screen or otherwise invisible objects. The Pause buttons may represent selections of seconds of lapsed time before the object returns to visibility. Time pauses may be scripted by means of correlating seconds lapsed during a cycle in which a change in the “alpha” or visibility level of the object decreases to a limit point and then increases back to visibility. Alternatively, pause buttons may be associated with variables that are entered as keyboard entries and thereby provide input for functions that allow the setting of specific timed intervals between loops of an animation action.

Pair buttons on animation menu 526 are designed to cause any two objects selected as a pair to be affected simultaneously by any single animation or editing command. This enables the user, for example, to set an animation on two objects so-that they run in tandem with all their movements and changes occurring at precisely the same time.

The present invention uses a method by which animation actions on container objects within each scene stop whenever the scene is not visible. The animations start again from where they stopped whenever the user returns to view the scene. This process works by means of interaction between sets of variables assigned to each container object on each scene. The action of selecting a scene for viewing causes all movie clips on that scene to be visible, i.e., to have a visibility state that is “true.” When the scene is not selected, i.e., is not being viewed by the user, the visibility state is “false.” As would be known to one skilled in the art, a variation in the process of determining visibility and invisibility of objects in a scene would be to apply the process to unique combinations of scenes that can be viewed together rather than to one scene at a time.

After the creator creates the rich media production, a creator may send a message with the URL that is associated with the production to multiple recipients using the email menu. The email menu allows the user to enter the addresses of multiple recipients in a text box or in multiple text boxes. The email menu includes a second text box for an email address where the sender intends to store a personal copy of the record of the rich media production. The creator may temporarily save and recall an email address entry. The recipient email address entry may be linked to an address book. The email menu allows the creator to enter additional information, such as a subject and message. The creator may then determine if the recipient of the email is to edit the rich media production. If the creator decides to allow the recipient to edit the rich media production, the creator selects an enablement option that enables the rich media production to be edited by the recipient. The creator then sends the email by selecting a Send button in the work area. The send button generates a unique name file for the rich media production session and also generates a file containing values for the variables in the production. Writer template 100 sends the session file and the variables file to a middleware software 128, such as but not limited to PHP operating on host server 120. Middleware software 128 accepts and reads the session and variable files and assigns each variable in the variable data file to its corresponding variable category in a unique text data string. The text data string is written and stored on server 120 and the text data string represents all of the features of the entire rich media production, including all the static and dynamic properties of all images in the production. Middleware software 128 inserts the unique file name for the text data string as part of a unique URL that is associated with the text data string. The unique file name is used to identify the location of the text data string in a database on host server 120. Middleware software 128 generates a unique HTML page that provides the options for the recipients of the email to access downloadable reader template 121 and the text data string for the rich media production. Middleware software 128 generates and sends an email file that contains the unique URL to the recipient.

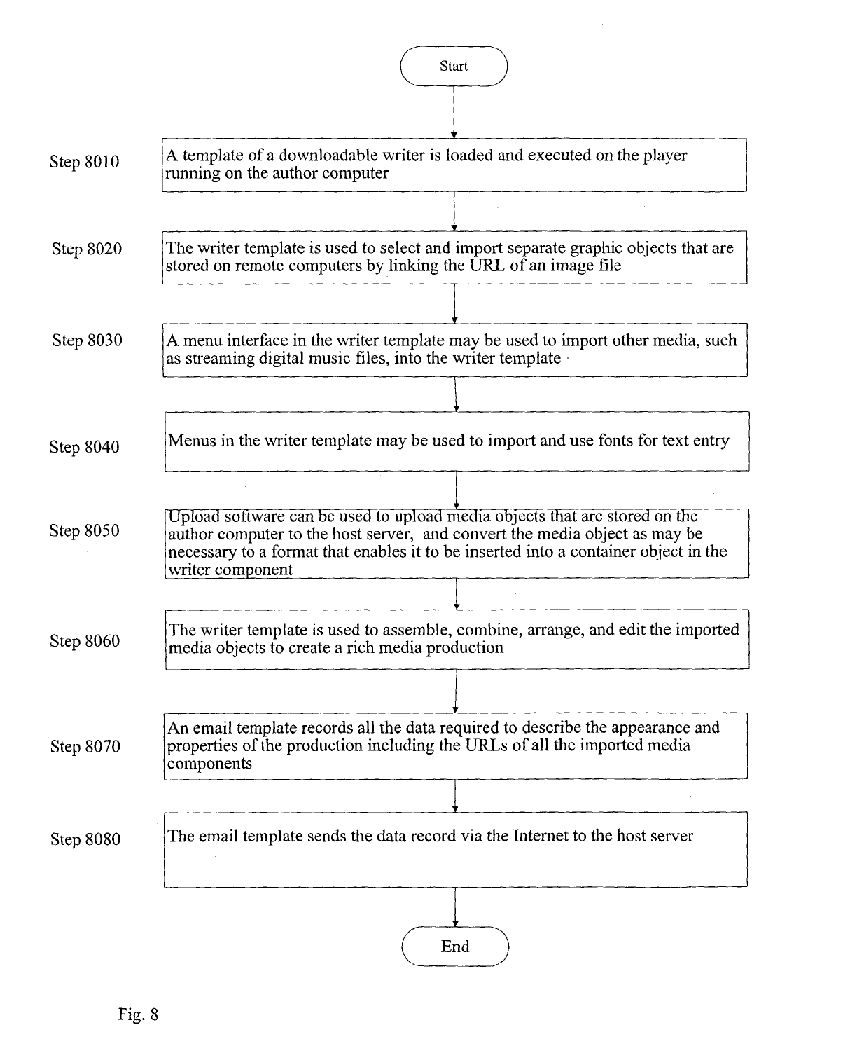

FIG. 8 illustrates steps implemented in the inventive system for identifying and importing graphic objects from various locations within the network. In Step 8010, a copy of downloadable writer 126 is loaded on writer template 100 and executed on player 112 running on author computer 110. In Step 8020, writer template 100 is used to select and import disparate graphic objects that are stored on remote computers by linking the URL of an image file. In step 8030, a menu interface in the writer template 100 may be used to import other media, such as streaming digital music files, into writer template 100. In Step 8040, menus in writer template 100 may be used to import and use fonts for text entry. In Step 8050, upload software can be used to upload media objects that are stored on author computer 110 to the host server 120, and convert the media object as may be necessary to a format that enables it to be inserted into a container object in writer template 100.

In Step 8060, writer template 100 is used to assemble, combine, arrange, and edit the imported media objects to create a rich media production. In Step 8070, an email template records all the data required to describe the appearance and properties of the production including the URLs of all the imported media components. In Step 8080, the email template sends the data record via the Internet to host server 120.

By activating the URL, a recipient of the email launches the web browser on recipient computer 140. The recipient accesses the unique HTML page by clicking the URL in email file. Upon accessing the HTML page, the recipient determines whether a fully enabled reader template is available. If the HTML page indicates that a fully enabled reader template is available, the recipient may elect to use it or to use a disabled reader template. A disabled reader template contains only navigational controls and does not contain tools that enable editing of the rich media production in recipient computer 140. If the creator indicated that the recipient could access the enabled reader template, the recipient may then enter a password to download reader template 146 from downloadable reader 121. Alternatively, the recipient could access an enabled reader template through subscription or membership. The recipient may select an option in the HTML page to load 2246 the enabled reader template to the recipient computer 140. The reader template may be downloaded from host server 120, or the reader template may be loaded from a preinstalled location in the user's local file storage. After the reader template is downloaded to reader template 146, player 112 in recipient computer 140, launches the reader template. Reader template 146 accesses and reads the unique data string from host server 120. Reader template 146 uses the data string to locate images and media used in the rich media production and loads the images and media into reader template 146. Reader template 146 uses the data string to load the variable values contained in the associated text data string. Reader template 146 applies the values of the variables to their corresponding objects in the rich media production, thereby reproducing the original appearance and properties of the rich media production. The display device on the recipient computer 140 displays the resulting rich media production.

In a preferred embodiment, all files used in the implementation of the present invention are initially located and stored on host server 120. As is apparent to one skilled in the art, files used in the inventive system may be stored on other computing units and such implementation is within the scope of the inventive system. Files used to implement the inventive system include downloadable writer software 126, various versions of reader software 121 each with differing capabilities of playback and display of recorded data string, and multiple menu files that are downloaded via network 150 as needed by writer template 100. The menu files include those used for importing, displaying, and editing graphics, menu files for selecting specific media content to be imported, media files that are selectable with menu files, and an interface file that passes data for recording the text data string on the server and that allows the creator to send a personal email message containing the URL of the string to multiple recipients. The inventive system preferably includes separately downloaded menus. However, menus may also be embedded in downloadable writer 126 to create a single file.

In the preferred embodiment of the present invention, multiple container objects in writer and reader templates 100 and 146 may be enabled to accept files delivered as a live video feed from another user with a video input device and software that enables peer to peer connections either directly or via a host server. Player 112 may be configured in conjunction with a multimedia communications server and application software, such as but not limited to the Macromedia Flash Communications Server MX. In the present invention, multiple instances of container objects capable of receiving live video or other live data may be used in multiple scenes in writer and reader templates 100 and 146 and used along with other container objects that are enabled to receive real time or interactive data in the templates. Standard chat software can also be combined in real time with writer and reader templates 100 and 146 for on-line collaboration.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed:

1. A system for designing and sharing rich media productions on client computers on a computer network, the system comprises:
at least one author computer for creating the rich media production by importing separate media elements from at least one remote component, wherein upon importing the separate media elements, the author computer assembles the separate media elements into the rich media production and the author computer associates a text record with the rich media production, the text record being used to identify media elements that were used to create the rich media production;
at least one recipient computer for using the text record to access the rich media production;
at least one host server for storing the text record, the host server also comprising a plurality of downloadable components that enable the author computer to create the rich media production and that enable the recipient computer to access the rich media production after the host server transmits a message from the author computer to the recipient computer, the message including information for enabling the recipient computer to access text record and thereby recreate the rich media production; and
means for downloading a writer template from the host server to the author computer prior to creating the rich media production and for downloading a reader template from the host server to the recipient computer prior to accessing the rich media production, wherein the downloaded writer template enables the author computer to import a plurality of elements from at least one remote component to create the rich media production and the reader template enables the recipient computer to access the text record to recreate the rich media production on the recipient computer.

2. The system of claim 1, wherein the author computer comprises a web browser with a player for launching the writer template.

3. The system of claim 1, wherein the writer template provides core functions for the creation of the rich media production and wherein the writer template is used to communicate with the host server.

4. The system of claim 1, wherein the writer template is used to download a plurality of media elements and a plurality of control elements from external components to the author computer, wherein the plurality of media elements are used to create the rich media production and the plurality of control elements are used to control functions in the writer template.

5. The system of claim 1, wherein a creator of a rich media production creates at least one personal account on at least one host server that is associated with media storage site.

6. The system of claim 5, wherein the creator uploads personal media files from the author computer to the media storage site, associates the personal media files with the at least one personal account and stores the media file on the at least one host server.

7. The system of claim 2, wherein the player displays instances of downloaded graphic objects in a stack of transparent layers, wherein levels in the player are subdivided into a plurality of layers and the plurality of layers are subdivided into depths and wherein the writer template uniquely identifies in the text record a location for each object in the player.

8. The system of claim 7, wherein level 0 in the player comprises most functional components in the writer template and placement of a graphic object in level 0 enables the creator to alter the depths of the graphic objects within a layer.

9. The system of claim 8, wherein level 0 comprises:
a plurality of instances of backgrounds;
a plurality of screen grids for providing temporary guides for placement of images on a work area;
a plurality of container objects within which imported graphic objects are contained and manipulated;
a plurality of screen frames, each of which is a multiple layered frame that surrounds a perimeter to the work area;
a plurality of scene transition movie clips that enable transitions between scenes in the writer template; and
a plurality of control menus for selecting, accessing, importing, and displaying graphic objects in the writer template.

10. The system of claim 1, wherein when the writer template is initially launched, the writer template appears as an empty work area with icon buttons that are designed to import menus that correspond to specific functional tasks.

11. The system of claim 10, wherein the menus are saved to a browser cache in the author computer.

12. The system of claim 10, wherein the icon buttons comprises:
an import menu icon for importing an import menu that controls how images are imported and displayed in the writer template;
a navigate icon for importing a navigate menu that enables a user to display different scenes in the rich media production;
an edit menu icon for importing an edit menu that may display icons for enabling the user to resize, rotate, shape, or color select images on the work area;
a backgrounds menu icon for displaying additional icons representing menus used to insert different background levels and frames;
an animation menu icon for importing an animation menu that enables the user to make still images move on a screen;
a send menu icon for importing a menu that enables the user to share a rich media production using email;
an audio/video menu icon for importing a menu that enables the user to add music, voice, or videos in the rich media production;
a print menu icon that launches the print function of the host server to enable the user to print any scene of the rich media production; and
a help menu icon that imports help and usage instructions.

13. The system of claim 10, wherein a stacking order menu in the writer template is designed to change the stacking order depth of a selected graphic object.

14. The system of claim 10, wherein the plurality of imported menus comprises:
an import menu interface further comprising a plurality of menus for importing graphic objects into the writer template, a font selection menu for accessing a menu of font files for inserting text in the writer template, and a remove menu for removing a selected graphic object from a container object;
a movement menu interface for manipulating rotation and dimensions of an imported graphic object;
a color menu for changing color of a selected graphic object, for changing color and transparency of a selected background and for changing color of a plurality of other components in the writer template;
a background menu interface for selecting and loading different background levels into the writer template;
an edit menu for affecting appearances of a selected text box;
an email menu for entering at least one address for a recipient of the rich media production and for determining if the recipient is to edit the rich media production by selecting an enablement option;
an animation menu with animation instructions for affecting behavior of a selected graphic object through variables that are associated with the selected graphic object; and
a navigation menu that facilitates selection of scenes to be displayed in the writer template and optional types of transition between scenes.

15. The system of claim 14, wherein the movement menu interface comprises buttons that control variables of a selected graphic object, wherein the buttons are designed to change variables linked to the selected graphic object by regular and precise increments, thereby causing a real time display of the selected graphic object that reflects the variable changes.

16. The system of claim 14, wherein the appearance of an embedded font is defined by negative space and wherein the fonts are mask fonts.

17. The system of claim 14, wherein upon selecting a send button in the email menu, the writer template generates a unique session file name for the rich media production, generates a variable file comprising values for the variables in the rich media production, and sends a session file to the host server.

18. The system of claim 17, wherein one of the plurality of components on the host computer accepts and reads the session file and the variable file and assigns each variable in the variable file to a corresponding variable category in a unique text data string that is stored on the host server, and wherein the text data string represents all of the features of the rich media production.

19. The system of claim 18, wherein one of the plurality of components on the host computer inserts a unique file name of a text data string in a URL that is associated with the text data string and generates a HTML page that provides options for accessing the reader template and the text data string to a recipient of the rich media production.

20. The system of claim 19, wherein the message transmitted to the reader template comprises the URL that is associated with the rich media production, the URL enables the recipient to access the HTML page and to determine whether an enabled reader template is available, the enabled reader template comprising a reader for displaying the rich media production and a writer with functions for editing the rich media production, and wherein if the enabled reader template is available, the recipient can access the enabled reader template by providing a pre-assigned password.

21. The system of claim 14, wherein each imported menu can exist simultaneously in the work area with other imported menus.

22. The system of claim 1, wherein each imported graphic object is associated with a container object in the writer template and each component object is assigned a set of pre-named variables for identifying properties of the container object and the associated graphic object.

23. The system of claim 22, wherein a plurality of graphic objects are displayed in a scene, wherein each associated container object is designed to respond to user inputs that determine the position, appearance and visibility of each graphic object.

24. A method for designing and sharing rich media productions on client computers on a computer network, the method comprises the steps of:
executing a web browser with a player for launching a writer template on an author computer;
downloading the writer template from a host server;
launching the writer template on the player;
selecting and importing separate graphic objects in separate files on at least one remote component into the writer template;
manipulating the imported separate graphic objects to create a rich media production;
generating an email record with an address of at least one recipient;
generating files for the rich media production and sending the files to the host server;
accepting and reading the files on the host server and assigning each variable in a variable file to a corresponding variable category in a unique text data string that is stored on the host server;
inserting a unique file name of the text data string in a URL that is associated with the text data string and generating an HTML page that provides options for accessing a reader template; and
using, by a recipient computer, the HTML page to access the reader template and the text data string and thereby recreate the rich media production.

25. The method of claim 24, wherein the step of generating files further comprises the steps of generating a unique session file name for the rich media production and generating a variable file comprising values for the variables in the rich media production.

26. A client computer for designing and sharing rich media productions on a computer network, the client computer comprises:
a writer template with core functions for creating a rich media production, wherein the writer template is used to communicate with a host server that stores a plurality of components;
a web browser with a player for launching the writer template; and
means for downloading the writer template, for downloading separate graphic objects in separate files from at least one external component, for manipulating the downloaded graphic objects to create the rich media production, for generating files for the rich media production and for sending the files to the host server, wherein the host server accepts the files, generates and stores a unique text data string that is associated with the rich media production, and transmits access to the text data string to a recipient that uses the text data string to recreate the rich media production.

27. The client computer of claim 26, wherein when the writer template is initially launched, the writer template appears as an empty work area with icon buttons that are designed to import menus that correspond to specific functional tasks.

28. The client computer of claim 27, wherein the menus are saved to a browser cache in the author computer.

29. The client computer of claim 27, wherein the icon buttons comprises:
an import menu icon for importing an import menu that controls how images are imported and displayed in the writer template;
a navigate icon for importing a navigate menu that enables a user to display different scenes in the rich media production;
an edit menu icon for importing an edit menu that may display icons for enabling the user to resize, rotate, shape, or color select images on the work area;
a backgrounds menu icon for displaying additional icons representing menus used to insert different background levels and frames;
an animation menu icon for importing an animation menu that enables the user to make still images move on a screen;
a send menu icon for importing a menu that enables the user to share a rich media production using email;
an audio/video menu icon for importing a menu that enables the user to add music, voice, or videos in the rich media production;
a print menu icon that launches the print function of the host server to enable the user to print any scene of the rich media production; and
a help menu icon that imports help and usage instructions.

30. The client computer of claim 27, wherein a stacking order menu in the writer template is designed to change the stacking order depth of a selected graphic object.

31. The client computer of claim 27, wherein the plurality of imported menus comprises:
an import menu interface further comprising a plurality of menus for importing graphic objects into the writer template, a font selection menu for accessing a menu of font files for inserting text in the writer template, and a remove menu for removing a selected graphic object from a container object;
a movement menu interface for manipulating rotation and dimensions of an imported graphic object;
a color menu for changing color of a selected graphic object, for changing color and transparency of a selected background and for changing color of a plurality of other components in the writer template;
a background menu interface for selecting and loading different background levels into the writer template;
an edit menu for affecting appearances of a selected text box;
an email menu for entering at least one address for a recipient of the rich media production and for determining if the recipient is to edit the rich media production by selecting an enablement option;
an animation menu with animation instructions for affecting behavior of a selected graphic object through variables that are associated with the selected graphic object; and
a navigation menu that facilitates selection of scenes to be displayed in the writer template and optional types of transition between scenes.

32. The client computer of claim 31, wherein the movement menu interface comprises buttons that control variables of a selected graphic object, wherein the buttons are designed to change variables linked to the selected graphic object by regular and precise increments, thereby causing a real time display of the selected graphic object that reflects the variable changes.

33. The client computer of claim 31, wherein the appearance of an embedded font is defined by negative space and wherein the fonts are mask fonts.

34. The client computer of claim 31, wherein upon selecting a send button in the email menu, the writer template generates a unique session file name for the rich media production, generates a variable file comprising values for the variables in the rich media production, and sends a session file to the host server.

35. The client computer of claim 34, wherein one of the plurality of components on the host computer accepts and reads the session file and the variable file and assigns each variable in the variable file to a corresponding variable category in a unique text data string that is stored on the host server, and wherein the text data string represents all of the features of the rich media production.

36. The client computer of claim 35, wherein one of the plurality of components on the host computer inserts a unique file name of a text data string in a URL that is associated with the text data string and generates a HTML page that provides options for accessing the reader template and the text data string to the recipient.

37. The client computer of claim 36, wherein the message transmitted to the reader template comprises the URL that is associated with the rich media production.

38. The client computer of claim 27, wherein each imported menu can exist simultaneously in the work area with other imported menus.

39. The client computer of claim 26, wherein each imported graphic object is associated with a container object in the writer template and each component object is assigned a set of pre-named variables for identifying properties of the container object and the associated graphic object.

40. The client computer of claim 39, wherein a plurality of graphic objects are displayed in a scene, wherein each associated container object is designed to respond to user inputs that determine the position, appearance and visibility of each graphic object.

41. A client computer for accessing a rich media production that is stored on a host computer, the client computer comprises:
a reader template with core functions for accessing a rich media production, wherein the reader template is used to communicate with a host server that stores a plurality of components including the reader template;
a web browser with a player for launching the reader template; and
means for activating a URL in an email that launches the web browser, for accessing a unique HTML page by clicking the URL in the email, for downloading the reader template, for launching the reader template wherein the reader template accesses and reads a unique data string from the host server and uses the data string to locate images and media used in the rich media production, and means for loading the images and media into the reader template and thereby reproduce the original appearance and properties of the rich media production.

42. The client computer of claim 41, wherein upon accessing the HTML page, the recipient determines whether an enabled reader template is available, the enabled reader template comprising a reader for displaying the rich media production and a writer with functions for editing the rich media production.

43. The client computer of claim 42, wherein if the enabled reader template is available, the recipient can access the enabled reader template if the recipient is a preregistered member.

44. The client computer of claim 43, wherein if the enabled reader template is unavailable, the recipient can access an un-enabled reader template that displays the rich media production.

45. The client computer of claim 42, wherein the recipient access the enabled reader template by entering a password to download the template from the host server.

46. The client computer of claim 42, wherein the data string is used to identify variable values associated with objects in the rich media production and reader template applies the variable values to their corresponding objects, thereby reproducing the original appearance and properties of the rich media production.

47. A system for designing and sharing rich media productions on client computers on a computer network, the system comprises:
at least one remote component that stores elements to be used in a rich media production;
at least one author computer for creating the rich media production by importing separate media elements from at least one remote component, wherein upon importing the separate media elements, the author computer assembles the separate media elements into the rich media production and the author computer associates a text record with the rich media production, the text record being used to identify media elements that were used to create the rich media production;
at least one recipient computer for using the text record to access the rich media production;
at least one host server for storing the text record, the host server also comprising a plurality of downloadable components that enable the author computer to create the rich media production and that enable the recipient computer to access the rich media production after the host server transmits a message from the author computer to the recipient computer, the message including information for enabling the recipient computer to access the text record; and
means for downloading a writer template from the host server to the author computer prior to creating the rich media production and for downloading a reader template from the host server to the recipient computer prior to accessing the text record, wherein the downloaded writer template enables the author computer to import a plurality of elements from the at least one remote component to create the rich media production and the reader template enables the recipient computer to access the text record to recreate the rich media production on the recipient computer.

48. The system of claim 47, wherein the plurality of downloadable components on the host server comprise a plurality of separate media elements, the writer template, at least one version of the reader template, a plurality of menu files for controlling functions in the writer template and the reader template, an interface file for passing data from the writer template to the host server and for passing the message from the host server to the recipient computer, a middleware software for accepting data associated with the rich media production and assigning variables associated with the rich media production to corresponding variable categories in the text record.

49. The system of claim 48, wherein upon creating the rich media production, the writer template generates a unique session file name for the rich media production, generates a variable file comprising values for the variables in the rich media production, and sends a session file to the middleware software.

50. The system of claim 49, wherein the middleware software accepts and reads the session file and the variable file and assigns each variable in the variable file to a corresponding variable category in a unique text data string that is stored on the host server, and wherein the text data string represents all of the features of the rich media production.

51. The system of claim 49, wherein the middleware software a inserts a unique file name of a text data string in a URL that is associated with the text data string and generates a HTML page that provides options for accessing the reader template and the text data string to the recipient.
